(19) United States
(12) Patent Application Publication
(10) Pub. No.: US 2014/0250178 A1
(43) Pub. Date: Sep. 4, 2014

(54) CONTENT BASED DISCOVERY OF SOCIAL CONNECTIONS

(71) Applicant: Google Inc., Mountain View, CA (US)

(72) Inventors: Bryan Christopher Horling, Sunnyvale, CA (US); Afsaneh Hajiamin Shirazi, San Jose, CA (US)

(73) Assignee: GOOGLE INC., Mountain View, CA (US)

(21) Appl. No.: 13/783,132

(22) Filed: Mar. 1, 2013

(51) Int. Cl. H04L 29/08

(52) U.S. Cl. CPC H04L 67/22
USPC 709/204

(57) ABSTRACT

Methods, systems, and computer-readable media are provided for identifying social connections. In some implementations, the occurrence of a first reference to a first person and a second reference to a second person is identified in unstructured data. A relationship metric is calculated between the first reference and the second reference, wherein the relationship metric is based at least in part on the co-occurrence of the first reference and the second reference. The existence of a potential connection between the first reference and the second reference is determined based at least in part on the relationship metric. A recommendation is provided to at least one of the first person and the second person to acknowledge the potential connection as an actual connection. Input is received from at least one of the first person and the second person confirming the potential connection as an actual connection.

### BACKGROUND

This disclosure generally relates to identifying social connections. Social connections exist between persons in, for example, a social network. Connections are suggested to users of the social network based on user input and existing social connections as defined in a structured social connection data maintained by the social network.

### SUMMARY

In some implementations, social connections are identified based on unstructured content. For example, the system may extract information from unstructured Internet content to identify connections between persons that may not otherwise be known, such as in, for example, a social network. In an example, a professor and a graduate student may both appear in a number of journal publications, and the system may identify a relationship between them based on these appearances.

In some implementations, a computer-implemented method includes identifying an occurrence of a first reference to a first person and a second reference to a second person in an unstructured collection of electronic documents. The method includes calculating a relationship metric between the first reference and the second reference, wherein the relationship metric is based at least in part on the co-occurrence of the first reference and the second reference. The method includes determining the existence of a potential connection between the first reference and the second reference based at least in part on the relationship metric. The method includes providing a recommendation to at least one of the first person and the second person to acknowledge the potential connection as an actual connection. The method includes receiving input from at least one of the first person and the second person confirming the potential connection as an actual connection. Other implementations of this aspect include corresponding systems and computer programs, configured to perform the actions of the methods, encoded on computer storage devices.

These and other implementations can each include one or more of the following features. In some implementations, identifying an occurrence of at least one of the first reference and the second reference comprises mapping a reference in at least one document of the collection of electronic documents to a reference in a list. In some implementations, determining the existence of a potential connection comprises comparing the relationship metric to a threshold. In some implementations, the relationship metric is determined based at least in part on the location of at least one of the first reference and the second reference in one of the documents of the collection of electronic documents. In some implementations, the relationship metric is determined based at least in part on the distance between the occurrence of the first reference and the occurrence of the second reference in one of the documents of the collection of electronic documents. In some implementations, the relationship metric is determined based at least in part on a number of occurrences of at least one of the first reference and the second reference in at least one of the documents of the collection of electronic documents. In some implementations, the relationship metric is determined based at least in part on a quality metric associated with one or more of the documents of the collection of electronic documents. In some implementations, the method further comprises augmenting social connection data associated with at least one of the first person and the second person based on the actual connection.

One or more of the implementations of the subject matter described herein may provide one or more of the following advantages. In some implementations, social connections may be identified in situations where a social connection would not otherwise have been known. In some implementations, emerging connections that might appear recent news articles or other publications may be identified.

### BRIEF DESCRIPTION OF THE FIGURES

FIG. 1 is a high level block diagram of a system for identifying social connections in accordance with some implementations of the present disclosure;

FIG. 2 shows an illustrative example of identifying social connections in accordance with some implementations of the present disclosure;

FIG. 3 shows an exemplary user interface sequence for providing potential social connections in accordance with some implementations of the present disclosure;

FIG. 4 shows a flow diagram of illustrative steps for identifying social connections in accordance with some implementations of the present disclosure;

FIG. 5 shows an illustrative computer system for identifying social connections in accordance with some implementations of the present disclosure; and

FIG. 6 is a block diagram of a computer in accordance with some implementations of the present disclosure.

### DETAILED DESCRIPTION OF THE FIGURES

In some implementations, potential social connections are identified by analyzing social connection data associated with, for example, a social networking platform. In an example, a potential social connection is identified based on a friends-of-friends relationship. A friends-of-friends relationship occurs where a first person is connected to a second person, who is connected to a third person. In the example, a proposed social connection between the first and the third person is identified, based on the shared connection with the second person. In some implementations, potential connections are identified using data other than, or in addition to, social connection data. For example, potential and actual social connections may be identified from unstructured content.

Unstructured content, as used herein, refers to text, audio, video, and other content that is not categorized, labeled, or otherwise identified as relating to a particular type of information in a universal way. In an example, data contained in the labeled fields of a database is considered to be structured data, while a plain text document contains unstructured data. In another example, the information “Name: Michael; City: San Francisco; Date of Birth Jun. 1, 1975” is considered structured content because each piece of information is given a defined category, while the information “Michael lives in San Francisco and was born on the first of July in 1975” is unstructured content referring to the same information.

In some implementations, a social network is a system that maintains relationships between persons. The term “person,” as used herein, includes, for example, one or more individuals, one or more groups of individuals, one or more companies, any other suitable entity, or any combination thereof. As used herein, an entity is a thing or concept that is singular, unique, well-defined and distinguishable. For example, an entity may be a person, place, item, idea, abstract concept, concrete element, other suitable thing, or any combination thereof. For example, a person, as defined above, may be an entity. In an example, a social network contains a number of persons, and contains information related to the connections that exist between at least some of those persons. In some implementations, the collection of relationships between persons in a social network is referred to as social connection data. In an example, a person in a social network has associated social connection data containing confirmed connections with other persons in the social network. Social connection data may include, for example, a list or graph of connections.

In some implementations, a relationship between persons in a social network represents a known connection between two or more persons. Connections may be unidirectional or bidirectional. In some implementations, a unidirectional relationship exists where only one person in the relationship has confirmed a connection with the other person. In an example, a first person may establish a unidirectional relationship with a famous celebrity without the celebrity knowing or acknowledging the first person. In some implementations, a bidirectional relationship requires both persons in the relationship to acknowledge the relationship. In an example, a first person may request a relationship with a second person, and the system may receive confirmation from the second person acknowledging the connection before a relationship is confirmed. In an example, a bidirectional relationship between two persons on a social network is indicative of a real-life friendship or other acquaintanceship between those persons. It will be understood that a real-life friendship need not exist for a relationship to be reflected by social connection data.

In some implementations, social connection data represents a web of business relationships between individuals, companies, groups, and other persons. In some implementations, social connection data represents a web or network of connections between individuals within a certain community, region, or worldwide.

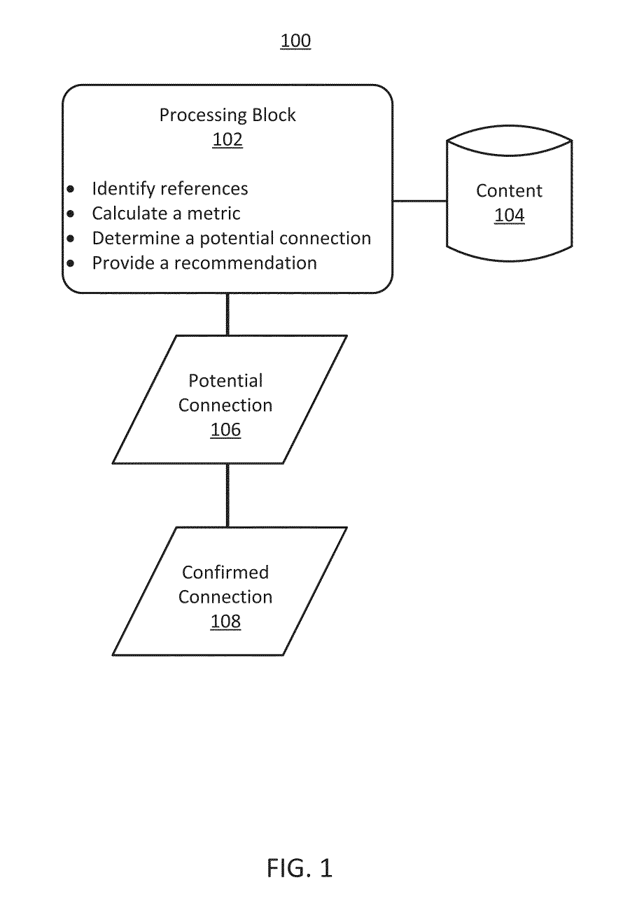

It will be understood that while the system is described in terms of identifying social connections, the technique may be applied to determining other types of connections between any suitable persons. For example, the system of FIG. 1, below, may identify potential relationships between entities such as organizations, universities, companies, groups, and other collections of individuals. It will also be understood that while the system is described in terms of identifying connections between persons, it may identify connections between a person and a non-person entities, and between non-person entity and a non-person entity. In an example, the system identifies a connection between a person and a topic or activity such as a relationship between an actor and a movie in which he or she performed. In another example, the system identifies a connection between related topics, such as the relationship between a computer operating system and software programmed to run on that operating system.

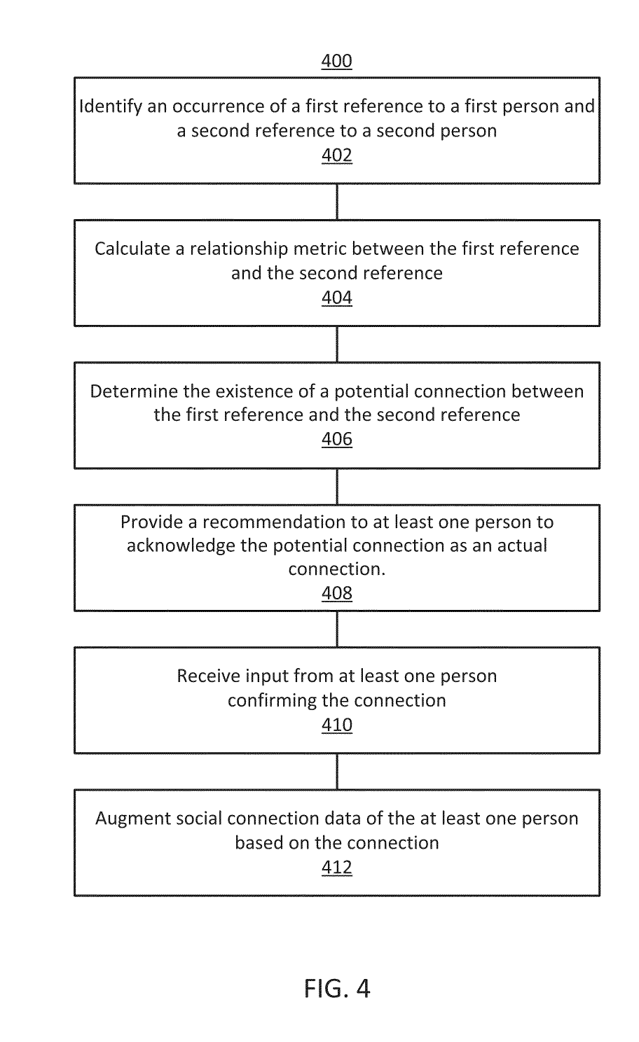

FIG. 1 is a high level block diagram of a system for identifying social connections in accordance with some implementations of the present disclosure. System 100 includes processing block 102, content block 104, potential connection block 106, and confirmed connection block 108. System 100 may be any suitable hardware, software, or both for implementing the features described in the present disclosure and will generally be referred to, herein, as “the system.” In some implementations, processing block 102 identifies a potential social connection between a first and a second person based on, for example, unstructured content of electronic documents. In some implementations, content block 104 includes electronic documents. In some implementations, the electronic documents include webpages from the world wide web or elsewhere on the internet, text files, database files, private network content, videos, audio, images, any other suitable public or private data, an index of the aforementioned content, or any combination thereof. In some implementations, processing block 102 processes data from content 104 to determine potential social connections. Processing steps include identifying references to persons in the content, calculating a metric based on the references, and determining a potential connection between persons based on that metric. In some implementations, the potential connection in potential connection block 106 is provided as a recommended connection to at least one person of the potential connection. In some implementations, processing block 102 receives an acknowledgement from a user confirming that the potential connection is an actual connection. Confirmed connection block 108 includes a confirmed connection based on the potential connection of potential connection block 106 being acknowledged as an actual connection. In some implementations, acknowledging a connection includes accepting a friend request or confirming a relationship. The techniques of system 100 are described in detail below in relation to flow diagram 400 of FIG. 4.

System 100 provides potential social connections in potential connection block 106. In some implementations, potential connection block 106 includes one or more potential pairs of persons that system 100 expects to represent a connection. In some implementations, a potential connection between two persons in a social network is identified by the names of the two persons appearing near to one another in one or more documents. In an example, the names of two scientists in the same university research group appear in a journal article that is retrieved from content block 104. The connection between the two persons is identified by processing block 102 based on the co-occurrence of both persons, and provided in potential connection block 106. Co-occurrence, as used herein, refers to the occurrence of two or more references to persons, for example, names, within a document. In an example, the names of a first and second politician appearing in a news article are said to co-occur. In some implementations, the system determines a co-occurrence value based on, for example, the distance between the occurrences and the number of occurrences within a document. It will be understood that in some implementations, one or more names are associated with a unique identifier, and co-occurrence is determined between the identifiers. For example, a common name such as “John Smith” may be associated with a unique identification number in order to disambiguate occurrences of that name.

In some implementations, the system may receive input acknowledging from a user or from another system that a potential connection provided in potential connection block 106 is a confirmed connection. In some implementations, the system provides the confirmed connection in confirmed connection block 108. In some implementations, the data from confirmed connection block 108 is used to augment the social connection data of one or both persons in the confirmed connection. In an example, a connection is confirmed between a first person and a second person, then the second person is then added to a list of friends maintained by the system for the first person and the first person is added to a list of friends maintained for the second person.

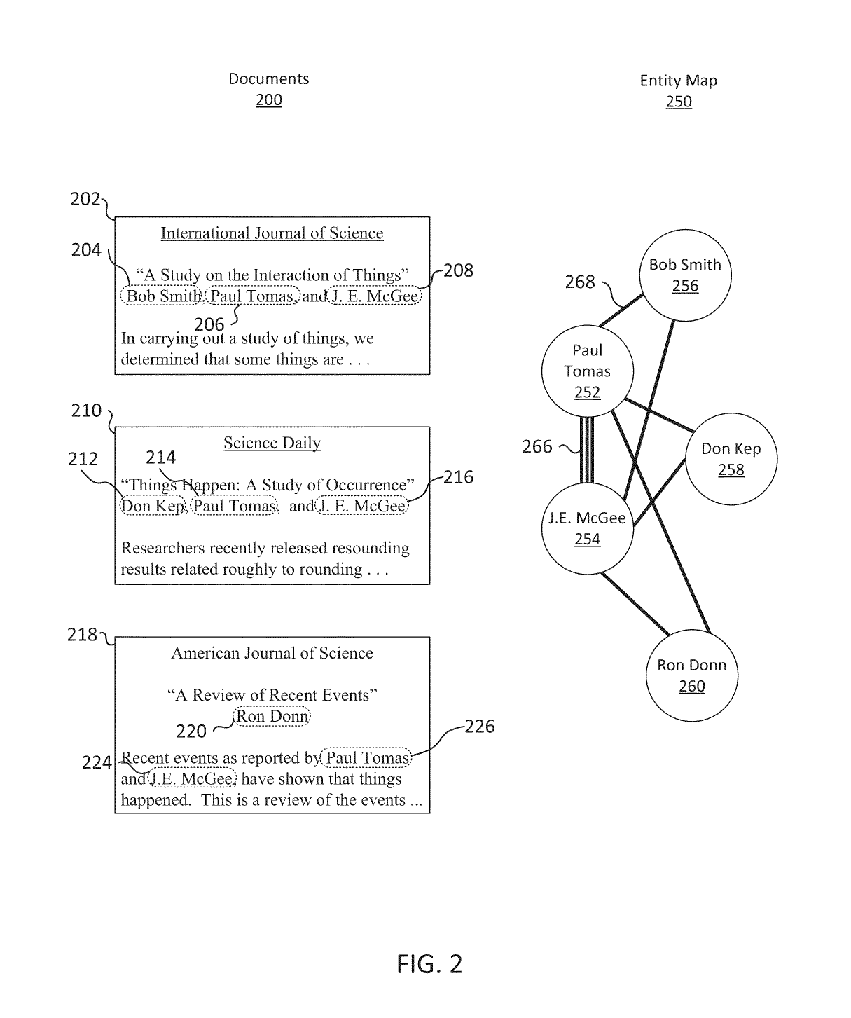

FIG. 2 shows an illustrative example of identifying social connections in accordance with some implementations of the present disclosure. FIG. 2 includes documents 200 illustrating three academic journal articles from which the system determines potential social connections, and entity map 250 which illustrates how the system identifies connections. In the illustrated example, a potential relationship is identified between two of the authors, “Paul Tomas” and “J. E. McGee.”

Documents 200 includes journal article 202, journal article 210, and journal article 218. Entity map 250 shows references identified in the articles. In the illustrated example, the system identifies references corresponding to persons in the articles. “Bob Smith” text 204, “Paul Tomas” text 206, and “J. E. McGee” text 208 are identified in article 202. The texts are identified as references by mapping to entity map 250. For example, the system identifies “Bob Smith” text 204 as corresponding to “Bob Smith” entity 256, the system identifies “Paul Tomas” text 206 as corresponding to “Paul Tomas” entity 252, and the system identifies “J. E. McGee” text 208 as corresponding to “J. E. McGee” entity 254. The mapping of, for example, unstructured text to entities will be described in detail below in step 402 of FIG. 4.

Journal article 210 includes “Don Kep” text 212 which is mapped to “Don Kep” entity 258, “Paul Tomas” text” 214 which is mapped to “Paul Tomas” entity 252, and “J. E. McGee” text 216 which is mapped to “J. E. McGee” entity 254. Journal article 218 includes “Ron Donn” text 220 which is mapped to “Ron Donn” entity 260, “Paul Tomas” text” 226 which is mapped to “Paul Tomas” entity 252, and “J. E. McGee” text 224 which is mapped to “J. E. McGee” entity 254.

A relationship metric describing the strength of a relationship between entity pairs occurring in journal articles 202, 210, and 218 is represented by the lines between the entities in entity map 250. The relationship metric will be described in detail in step 404 of FIG. 4 below. In an example, the relationship metric may be based in part on any one or more of the frequency of occurrence, distance between occurrences, and location of one or both occurrences, of the references in the unstructured text. In some implementations, the relationship metric includes co-occurrence. In some implementations, co-occurrence is based in part on the number of times the two references occur in a document, the distance between the references in the text, the position of one or both occurrences within the unstructured content, the appearance of one or both references in structured content, contextual information, any other suitable one or more criteria, or any combination thereof. For example, the system may identify the co-occurrence of two names adjacent in the text, such as “Bob Smith” text 204 and “Paul Tomas” text 206 as a stronger relationship than the two names relatively farther apart, such as “Bob Smith” text 204 and “J. E. McGee” text 208. In an example related to the position of one or both occurrences within unstructured content, the position of “Ron Donn” text 220 near the top of journal article 218 may indicate that its relationship to the other names in the article are relatively stronger than if the “Ron Donn” text 220 appeared at the bottom of the page. In some implementations, co-occurrence may be determined based on document text or other content, unique identifiers associated with text or other content, any other suitable information, or any combination thereof. In some implementations, a number of times that names co-occur in a text is based on an absolute count of occurrences, a count of occurrences relative to the length of the document, that is to say, a frequency of co-occurrence, any other suitable count of occurrences, or any combination thereof.

In the illustrated example, “Bob Smith” and “Paul Tomas” occur together once, in journal article 202. This is reflected by a single line 268 in the entity map connecting “Bob Smith” entity 256 and “Paul Tomas” entity 252. The co-occurrence of text mapped to “Paul Tomas” entity 252 and text mapped to “J. E. McGee” entity 254 in the three journal articles is reflected by the triple line 266 connecting “Paul Tomas” entity 252 and “J. E. McGee” entity 254. In some implementations, the strength of the relationship metric as represented by the number of lines between entities of entities map 250 is used to determine potential connections. In the illustrated example, a potential connection may be identified between “Paul Tomas” entity 252 and “J. E. McGee” entity 254 based on the strength indicated by triple line 266. Identifying potential connections is described in further detail below in step 406 of FIG. 4.

The illustrated example of FIG. 2 indicates a relationship metric based on a count of times that two names co-occur in journal articles. It will be understood that, as described above, the relationship metric may depend on other data in addition to or in place of the number of co-occurrences.

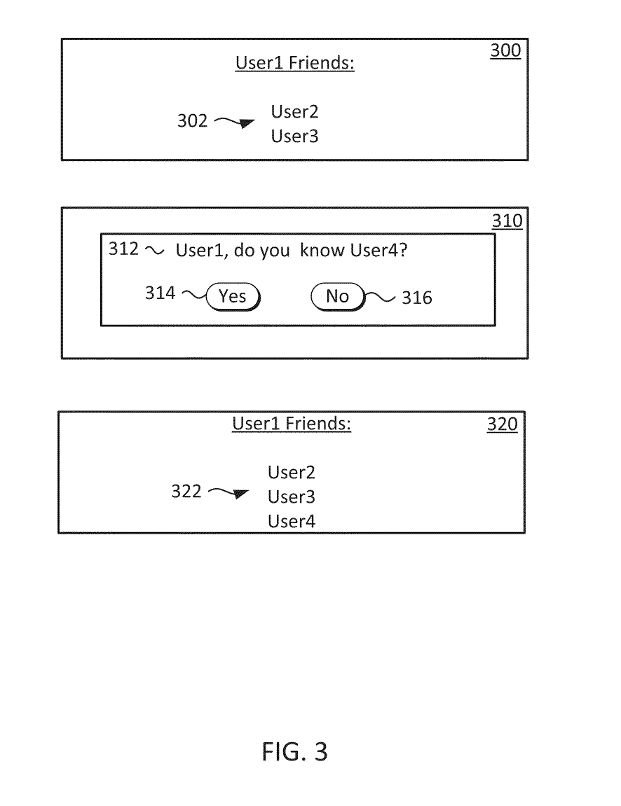

FIG. 3 shows an exemplary user interface sequence for providing potential social connections in accordance with some implementations of the present disclosure. Illustrative steps to provide a social connection, receive input from a user acknowledging the connection, and update social connection data associated with a user based on the received input are shown. In the example illustrated in FIG. 2 above, the system determines a potential connection between “Paul Tomas” and “J. E. McGee.” The system may provide the potential connection to a user associated with the entity “Paul Tomas,” and if he acknowledges that the proposed connection is a real and/or desired connection, “J. E. McGee” may be added to Paul Tomas's social connection data, which may be, for example, a list of friends. In some implementations, social connection data includes a list of social connections, a graph containing edges and nodes that represent social connections to other persons, any other suitable representation of connections, or any combination thereof.

User interface 300 shows social connection data 302 associated with User1. In the illustrated example, social connection data 302 includes a list of User1's friends, which includes User2 and User3. In some implementations, social connection data 302 includes a collection of confirmed friends for User1. In the illustrated example, User1 has previously acknowledged or otherwise confirmed that he or she is friends with User2 and User3.

In some implementations, social connection data 302 includes a list, grid, matrix, or other arrangement of data. In some implementations, friends are displayed using text, images, video, audio, demographic information, any other suitable content, or any combination thereof.

User interface 310 shows the system providing a potential social connection to User1. In the example, the system has identified a potential connection between User1 and User4. The system asks question 312 including the text “User1, do you know User4?” to User1. In some implementations, the potential connection is identified as shown in relation to FIG. 2 and as described below in step 404 of FIG. 4. The system includes two input response buttons, “Yes” button 314 and “No” button 316. The system receives input from a user using the buttons to confirm or reject the potential connection. For example, if User1 wants to add User4 to his or her social graph, User1 may click “Yes” button 314 using a mouse, keyboard, touchscreen, or other suitable input. The system receives this input as an acknowledgement of the potential connection as being an actual and/or desired connection.

User interface 320 shows exemplary social connection data 322 after the system receives an acknowledgement of the proposed connection in user interface 310 using “Yes” button 314. As shown, social connection data 322 of User1 includes User2, User3, and User4. In some implementations, social connection data 322 corresponds to social connection data 302 after augmenting the graph with the information that there is a relationship between User1 and User4.

FIG. 4 shows flow diagram 400 including illustrative steps for identifying social connections in accordance with some implementations of the present disclosure.

In step 402, the system identifies an occurrence of a first reference to a first person and a second reference to a second person. In some implementations, the system identifies references in an unstructured collection of electronic documents. A reference to a person in an electronic document includes the name, part of the name, any other suitable identifying information associated with that person, or any combination thereof. A reference may occur in the text, picture captions, anchor text, metadata, page title, any other suitable location, or any combination thereof. For example, a particular person's first and last name may appear in the text of a webpage. In another example, a person's last name may appear in the page title of a webpage. In another example, the system may associate identifying information such as “the 42^{nd} president of the United States” appearing in the text of a webpage with the person President Bill Clinton.

In some implementations, the system identifies a reference to a person as corresponding to a particular unique individual. In an example, the name “Michael Jackson” appears on a webpage. The system associates the reference “Michael Jackson” with either the musician Michael Jackson or the author Michael Jackson in a disambiguation step. The system may perform the disambiguation based on other text in the document, contextual information, metadata, links, for example, hyperlinks, to and from the document where the reference appears, contextual information related to the unique individual such as a popularity score or known social connections, any other suitable information, or any combination thereof. In some implementations, the system correlates references in a document to a maintained collection of previously known unique individuals. The collection of individuals is generated based on, for example, previous processing of social connections, crawling of webpages, a clustering process, manual input to social networks, any other suitable technique, or any combination thereof.

In some implementations, the system identifies a first reference to a first person and second reference to a second person. It will be understood that the system may identify any suitable number of references to any suitable number of persons in identifying social connections.

In step 404, the system calculates a relationship metric between the first reference and the second reference. In some implementations, the relationship metric is based at least in part on the co-occurrence of the first reference and the second reference.

In some implementations, the distance between a first reference and a second reference is used in part to determine a relationship metric such as co-occurrence. In an example, the system determines a relatively stronger relationship metric between references that are close together as compared to references that are further apart. In some implementations, the system determines the relationship metric based in part on the number and/or frequency of occurrences of one or both references in a document, where number is an absolute count within a document and frequency is a count within the document divided by the length of the document. In some implementations, the system determines the relationship metric based in part on the number and/or frequency of occurrences of one or both references across a number of documents.

In some implementations, a relationship metric is based on properties associated with the first reference, properties associated with the second reference, properties associated with the combination of references, any other suitable properties, or any combination thereof. In an example, properties associated with the first or second reference include the location of the reference within the document, the location of the reference within a paragraph or text block, how many times the reference occurs within the document, any other suitable parameters, or any combination thereof. For example, the relationship metric may be based in part on a reference occurring at the top of the page, a reference occurring in the first sentence of a paragraph, a reference occurring within a title, a reference occurring within a picture caption, a reference occurring a large number of times, a reference occurring a large number of times with respect to the total length of the document, a reference occurring in any other suitable location or manner, or any combination thereof.

In some implementations, the system determines a relationship metric based in part on the document where the reference occurs. For example, a webpage may be associated with a popularity score, a freshness score, a rating based on the number of hyperlinks to and from that page, a manual ranking, any other suitable metric, or any combination thereof. In some implementations, the system determines the relationship metric based in part on one or more of those document rankings.

In some implementations, the system may scale, normalize, weight, combine with other data, or otherwise adjust a relationship metric, such as a co-occurrence value, based on page quality, freshness, popularity, user input, system design, any other suitable criteria, or any combination thereof. In an example, the co-occurrence value from a recently updated webpage may be weighted with a higher weight than a co-occurrence value from an older webpage. In another example, the co-occurrence value across a number of webpages may be normalized such that each document has the same relative contribution to an aggregate score. In another example, co-occurrence values from highly visited webpages are assigned a higher weight than co-occurrence values from infrequently visited websites.

An illustrative expression for determining co-occurrence C(FR,SRⱼ) is shown by Eq. 1:

$$C ( FR , {SR}_{j} ) = \frac{P ( FR , {SR}_{j} )}{P ( FR )} \qquad ( 1 )$$

in which P(FR) is the probability of finding first reference FR in a text corpus, e.g. one or more webpages, and P(FR,SRⱼ) is the probability of finding both the first reference FR and the related second reference SRⱼ, indexed by index j, in the text corpus. Another illustrative expression for determining co-occurrence C(FR,SRⱼ) is shown by Eq. 2:

$$C ( FR , {SR}_{j} ) = \frac{N ( FR , {SR}_{j} )}{N ( FR ) + N ( {SR}_{j} ) - N ( FR , {SR}_{j} )} \qquad ( 2 )$$

in which N(FR) is the number of instances of first reference FR in a text corpus, e.g. one or more webpages, N(SRⱼ) is the number of instances of second reference SRⱼ, in the text corpus, e.g. one or more webpages, and N(FR,SRⱼ) is the number of instances of both the first reference FR and the second reference SRⱼ, the text corpus. In some implementations, the system may normalize, scale, shift, or otherwise alter the co-occurrence metric. It will be understood that the aforementioned equations are merely an example and that the system may use any suitable equation, technique, other suitable processing, or any combination thereof, to determine a co-occurrence metric.

It will be understood that any suitable technique or combination of techniques may be used to determine a relationship metric. For example, determining a metric may include analysis of co-occurrence, analysis of demographic information, analysis of geographic information, analysis of contextual information, any other suitable analysis or technique, or any combination thereof. For example, a relationship between a first person and a second person may be based on their occurrence in unstructured text in combination with other information from a social network such as demographic or geographic information. In another example, the system may include contextual information such as other words or content nearby the person reference in determining a relationship metric. In some implementations, the system may identify references in unstructured data, structured data, or any combination thereof.

In step 406, the system determines the existence of a potential connection between the first reference and the second reference. In some implementations, the system determines the potential connection based in part on the relationship metric defined by the first reference and the second reference. For example, the system determines a potential relationship by comparing the metric to one or more thresholds, to other relationship metrics, to any other suitable criteria, or any combination thereof. In some implementations, thresholds and criteria are determined based on user input, system design, predetermined parameters, system settings, machine learning based on previous determinations of relationships, user preferences, any other suitable data, or any combination thereof. In an example, the relationship metric determined between a first reference and a second reference is compared to a threshold to determine if it represents a potential connection.

It will be understood that, in some implementations, the system need not use a threshold in step 406. In an example, the system may determine the existence of a potential connection based on a relative comparison between two or more metrics. In another example, the system may identify all of the relationships between a first and second person as potential connections. In another example, the system may include user input in determining the existence of a potential connection, for example, a user providing content, access to content, or identification of content where potential connections are identified.

In step 408, the system provides a recommendation to at least one of the first person and the second person to acknowledge the potential connection as an actual connection. In an example, the system may provide a connection as shown in user interface 310 of FIG. 3. In an example, the system may provide a recommendation to the first person, where the first person and the second person are determined to have a potential connection. In another example, the system may provide a recommendation to both the first person and the second person. In some implementations, the system may provide the recommendation to one or both of the persons based on the relationship metric, user preferences, system design, previous user interactions with the system, any other suitable information, or any combination thereof.

In an example, the system provides a list, grid, matrix, or other display of potential connections to one or both persons. In an example, a potential connection is only displayed to a second person after it is confirmed by the first person.

In step 410, the system receives input from at least one of the first person and the second person confirming the connection. In some implementations, the system receives confirmation regarding a recommendation of a potential connection provided in step 408. In an example, the system may receive input as shown in user interface 310 of FIG. 3. For example, the system may provide information to a first person that there exists a potential connection between that first person and a second person. The first person may confirm that they know the second person or otherwise desire to establish a connection with that person, thus acknowledging that the potential connection is an actual connection. In some implementations, acknowledging a potential connection includes acknowledging a real-world connection, a previously known connection, a desired connection, any other suitable connection, or any combination thereof. In some implementations, receiving input may include receiving mouse input, keyboard input, touchscreen input, voice input, input from another system, any other suitable input, or any combination thereof. In an example, the person may confirm one or more actual connections from a list or grid of potential connections provided in step 408. In another example, the system may provide a potential connection to a second person, where the potential connection has been confirmed and/or requested by the first person. The system may receive from the second person an acknowledgement, denial, deferral, or other input regarding the connection.

In some implementations, the system provides a recommendation to a third person not otherwise included in the potential connection. The system may provide the third person the ability to acknowledge the connection as a real connection. In an example, in acknowledging potential historical social connections, such as connections between U.S. Presidents of the 1800s based on a collection of newspaper articles, the system presents potential connections to a historian for acknowledgment as real connections.

It will be understood that person-to-person connections identified by the system in a social network are unidirectional or bidirectional. In some implementations, a unidirectional social connection exists where a first person establishes a connection with a second person, but there is no confirmed connection between with second person with the first. In an example, a first person may subscribe or follow a famous person's postings on a social network platform, without the famous person acknowledging a connection with the first person. In some implementations, a bidirectional connection may exist where a connection must be confirmed by both the first person and the second person, and both persons may receive contacts, postings, and other social information from the other person. In an example, a social network may require a connection request from a first person to be confirmed by the second in order to establish any social connection. In some implementations, group memberships include social connections between more than two persons. It will be understood that some social networks include unidirectional connections, bidirectional connections, group memberships, any other suitable connections, or any combination thereof.

In step 412, the system augments the social connection data of at least one of the first person and the second person based on the confirmed connection. In an example, the system augments the social connection data as shown in user interface 320 of FIG. 3. In some implementations, social connection data associated with a person includes a graph and/or listing of known social connections. In an example, persons are represented as nodes of a graph and connections between persons are represented as edges of the graph. It will be understood that in some implementations, a social graph is an illustrative construct and that connections between persons may be represented by lists of names and connections. In some implementations, augmenting the social connection data includes adding the acknowledged social connection to the previously known social connections associated with one or both persons. In an example, where a social connection is confirmed in step 410, that connection is added to the social connection data of the person that confirmed the connection. In another example, the connection is added to the social connection data of both persons in the confirmed connection.

It will be understood that the steps above are exemplary and that in some implementations, steps may be added, removed, omitted, repeated, reordered, modified in any other suitable way, or any combination thereof. In an example, multiple connections are confirmed in step 410 before augmenting the social connection data in step 412. In another example, the system may augment social connection data in step 412 without receiving confirmation in step 412. That is to say, in some implementations the system considers a potential connection to be an actual connection.

In another example, the existence of a potential connection determined in step 406 may be used, without providing the recommendation to at least one person and/or receiving confirmation, to suggest other related social connections, to determine or adjust rankings of search results, to determine or adjust rankings of other information such as social connections, to provide search results or other information to a user, for any other suitable purpose, or any combination thereof. For example, a potential connection between a first and second person may be used to suggest a relationship between a third person and a fourth person. In another example, a potential connection between a first person and a second person may be used to provide search results based in part on a first person to the second person. It will be understood that the aforementioned uses of the potential social connection without acknowledgement are merely exemplary and that the system may use the potential social connection in any suitable way.

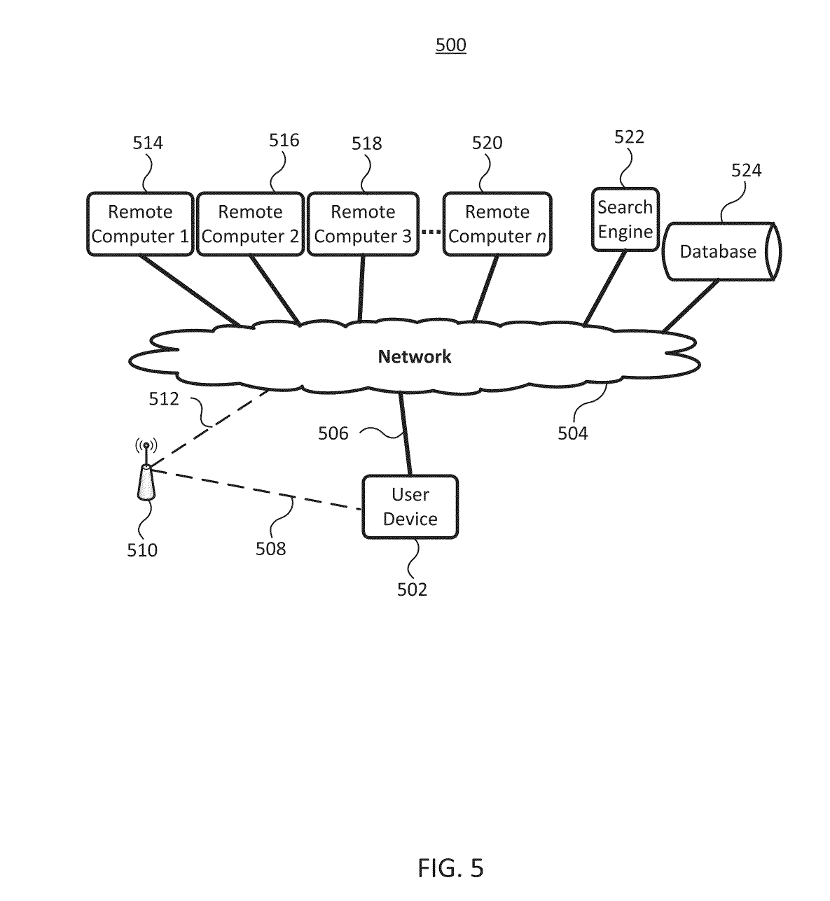

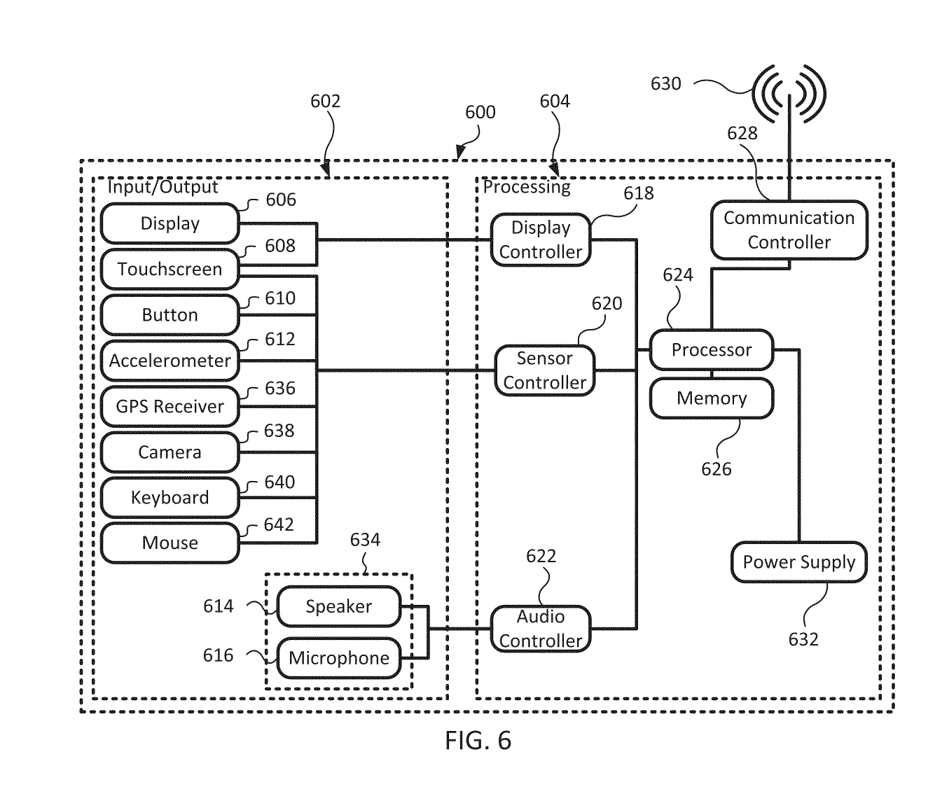

The following description and accompanying FIGS. 5 and 6 describe illustrative computer systems that may be used in some implementations of the present disclosure. It will be understood that elements of FIGS. 5 and 6 are merely exemplary and that any suitable elements may be added, removed, duplicated, replaced, or otherwise modified.

It will be understood that the system may be implemented on any suitable computer or combination of computers. In some implementations, the system is implemented in a distributed computer system including two or more computers. In an example, the system may use a cluster of computers located in one or more locations to perform processing and storage associated with the system. It will be understood that distributed computing may include any suitable parallel computing, distributed computing, network hardware, network software, centralized control, decentralized control, any other suitable implementations, or any combination thereof.

FIG. 5 shows an illustrative computer system that may be used by the system in accordance with some implementations of the present disclosure. System 500 may include one or more user device 502. In some implementations, user device 502, and any other device of system 500, includes one or more computers and/or one or more processors. In some implementations, a processor includes one or more hardware processors, for example, integrated circuits, one or more software modules, computer-readable media such as memory, firmware, or any combination thereof. In some implementations, user device 502 includes one or more computer-readable medium storing software, include instructions for execution by the one or more processors for performing the techniques discussed above with respect to FIG. 3, or any other techniques disclosed herein. In some implementations, user device 502 may include a smartphone, tablet computer, desktop computer, laptop computer, personal digital assistant or PDA, portable audio player, portable video player, mobile gaming device, other suitable user device capable of providing content, or any combination thereof.

User device 502 may be coupled to network 504 directly through connection 506, through wireless repeater 510, by any other suitable way of coupling to network 504, or by any combination thereof. Network 504 may include the Internet, a dispersed network of computers and servers, a local network, a public intranet, a private intranet, other coupled computing systems, or any combination thereof.

User device 502 may be coupled to network 504 by wired connection 506. Connection 506 may include Ethernet hardware, coaxial cable hardware, DSL hardware, T-1 hardware, fiber optic hardware, analog phone line hardware, any other suitable wired hardware capable of communicating, or any combination thereof. Connection 506 may include transmission techniques including TCP/IP transmission techniques, IEEE 602 transmission techniques, Ethernet transmission techniques, DSL transmission techniques, fiber optic transmission techniques, ITU-T transmission techniques, any other suitable transmission techniques, or any combination thereof.

User device 502 may be wirelessly coupled to network 504 by wireless connection 508. In some implementations, wireless repeater 510 receives transmitted information from user device 502 by wireless connection 508 and communicates it with network 504 by connection 512. Wireless repeater 510 receives information from network 504 by connection 512 and communicates it with user device 502 by wireless connection 508. In some implementations, wireless connection 508 may include cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Connection 512 may include Ethernet hardware, coaxial cable hardware, DSL hardware, T-1 hardware, fiber optic hardware, analog phone line hardware, wireless hardware, any other suitable hardware capable of communicating, or any combination thereof. Connection 512 may include wired transmission techniques including TCP/IP transmission techniques, IEEE 602 transmission techniques, Ethernet transmission techniques, DSL transmission techniques, fiber optic transmission techniques, ITU-T transmission techniques, any other suitable transmission techniques, or any combination thereof. Connection 512 may include may include wireless transmission techniques including cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Wireless repeater 510 may include any number of cellular phone transceivers, network routers, network switches, communication satellites, other devices for communicating information from user device 502 to network 504, or any combination thereof. It will be understood that the arrangement of connection 506, wireless connection 508 and connection 512 is merely illustrative and that system 500 may include any suitable number of any suitable devices coupling user device 502 to network 504. It will also be understood that any user device 502, may be communicatively coupled with any user device, remote server, local server, any other suitable processing equipment, or any combination thereof, and may be coupled using any suitable technique as described above.

In some implementations, any suitable number of remote servers 514, 516, 518 and 520, may be coupled to network 504. Remote servers may be general purpose, specific, or any combination thereof. In some implementations, any suitable number of remote servers 514, 516, 518, and 520 may be elements of a distributed computing network. One or more search engine servers 522 may be coupled to the network 504. In some implementations, search engine server 522 may include the data graph, may include processing equipment configured to access the data graph, may include processing equipment configured to receive search queries related to the data graph, may include any other suitable information or equipment, or any combination thereof. One or more database servers 524 may be coupled to network 504. In some implementations, database server 524 may store the data graph. In some implementations, where there is more than one data graph, the more than one may be included in database server 524, may be distributed across any suitable number of database servers and general purpose servers by any suitable technique, or any combination thereof. It will also be understood that the system may use any suitable number of general purpose, specific purpose, storage, processing, search, any other suitable server, or any combination.

FIG. 6 is a block diagram of a user device of the illustrative computer system of FIG. 5 in accordance with some implementations of the present disclosure. In some implementations, FIG. 6 includes computer 600. In some implementations, computer 600 is an illustrative local and/or remote computer that is part of a distributed computing system. Computer 600 may include input/output equipment 602 and processing equipment 604. Input/output equipment 602 may include display 606, touchscreen 608, button 610, accelerometer 612, global positions system or GPS receiver 636, camera 638, keyboard 640, mouse 642, and audio equipment 634 including speaker 614 and microphone 616. In some implementations, the equipment illustrated in FIG. 6 may be representative of equipment included in a user device such as a smartphone, laptop, desktop, tablet, or other suitable user device. It will be understood that the specific equipment included in the illustrative computer system may depend on the type of user device. For example, the Input/output equipment 602 of a desktop computer may include a keyboard 640 and mouse 642 and may omit accelerometer 612 and GPS receiver 636. It will be understood that computer 600 may omit any suitable illustrated elements, and may include equipment not shown such as media drives, data storage, communication devices, display devices, processing equipment, any other suitable equipment, or any combination thereof.

In some implementations, display 606 may include a liquid crystal display, light emitting diode display, organic light emitting diode display, amorphous organic light emitting diode display, plasma display, cathode ray tube display, projector display, any other suitable type of display capable of displaying content, or any combination thereof. Display 606 may be controlled by display controller 618 or by processor 624 in processing equipment 604, by processing equipment internal to display 606, by other controlling equipment, or by any combination thereof. In some implementations, display 606 may display data from a data graph.

Touchscreen 608 may include a sensor capable of sensing pressure input, capacitance input, resistance input, piezoelectric input, optical input, acoustic input, any other suitable input, or any combination thereof. Touchscreen 608 may be capable of receiving touch-based gestures. Received gestures may include information relating to one or more locations on the surface of touchscreen 608, pressure of the gesture, speed of the gesture, duration of the gesture, direction of paths traced on its surface by the gesture, motion of the device in relation to the gesture, other suitable information regarding a gesture, or any combination thereof. In some implementations, touchscreen 608 may be optically transparent and located above or below display 606. Touchscreen 608 may be coupled to and controlled by display controller 618, sensor controller 620, processor 624, any other suitable controller, or any combination thereof. In some implementations, touchscreen 608 may include a virtual keyboard capable of receiving, for example, a search query used to identify data in a data graph.

In some embodiments, a gesture received by touchscreen 608 may cause a corresponding display element to be displayed substantially concurrently, for example, immediately following or with a short delay, by display 606. For example, when the gesture is a movement of a finger or stylus along the surface of touchscreen 608, the system may cause a visible line of any suitable thickness, color, or pattern indicating the path of the gesture to be displayed on display 606. In some implementations, for example, a desktop computer using a mouse, the functions of the touchscreen may be fully or partially replaced using a mouse pointer displayed on the display screen. Button 610 may be one or more electromechanical push-button mechanism, slide mechanism, switch mechanism, rocker mechanism, toggle mechanism, other suitable mechanism, or any combination thereof. Button 610 may be included in touchscreen 608 as a predefined region of the touchscreen, e.g. soft keys. Button 610 may be included in touchscreen 608 as a region of the touchscreen defined by the system and indicated by display 606. Activation of button 610 may send a signal to sensor controller 620, processor 624, display controller 620, any other suitable processing equipment, or any combination thereof. Activation of button 610 may include receiving from the user a pushing gesture, sliding gesture, touching gesture, pressing gesture, time-based gesture, e.g. based on the duration of a push, any other suitable gesture, or any combination thereof.

Accelerometer 612 may be capable of receiving information about the motion characteristics, acceleration characteristics, orientation characteristics, inclination characteristics and other suitable characteristics, or any combination thereof, of computer 600. Accelerometer 612 may be a mechanical device, microelectromechanical or MEMS device, nanoelectromechanical or NEMS device, solid state device, any other suitable sensing device, or any combination thereof. In some implementations, accelerometer 612 may be a 3-axis piezoelectric microelectromechanical integrated circuit which is configured to sense acceleration, orientation, or other suitable characteristics by sensing a change in the capacitance of an internal structure. Accelerometer 612 may be coupled to touchscreen 608 such that information received by accelerometer 612 with respect to a gesture is used at least in part by processing equipment 604 to interpret the gesture.

Global positioning system or GPS receiver 636 may be capable of receiving signals from global positioning satellites. In some implementations, GPS receiver 636 may receive information from one or more satellites orbiting the earth, the information including time, orbit, and other information related to the satellite. This information may be used to calculate the location of computer 600 on the surface of the earth. GPS receiver 636 may include a barometer, not shown, to improve the accuracy of the location. GPS receiver 636 may receive information from other wired and wireless communication sources regarding the location of computer 600. For example, the identity and location of nearby cellular phone towers may be used in place of, or in addition to, GPS data to determine the location of computer 600.

Camera 638 may include one or more sensors to detect light. In some implementations, camera 638 may receive video images, still images, or both. Camera 638 may include a charged coupled device or CCD sensor, a complementary metal oxide semiconductor or CMOS sensor, a photocell sensor, an IR sensor, any other suitable sensor, or any combination thereof. In some implementations, camera 638 may include a device capable of generating light to illuminate a subject, for example, an LED light. Camera 638 may communicate information captured by the one or more sensor to sensor controller 620, to processor 624, to any other suitable equipment, or any combination thereof. Camera 638 may include lenses, filters, and other suitable optical equipment. It will be understood that computer 600 may include any suitable number of camera 638.

Audio equipment 634 may include sensors and processing equipment for receiving and transmitting information using acoustic or pressure waves. Speaker 614 may include equipment to produce acoustic waves in response to a signal. In some implementations, speaker 614 may include an electroacoustic transducer wherein an electromagnet is coupled to a diaphragm to produce acoustic waves in response to an electrical signal. Microphone 616 may include electroacoustic equipment to convert acoustic signals into electrical signals. In some implementations, a condenser-type microphone may use a diaphragm as a portion of a capacitor such that acoustic waves induce a capacitance change in the device, which may be used as an input signal by computer 600.

Speaker 614 and microphone 616 may be contained within computer 600, may be remote devices coupled to computer 600 by any suitable wired or wireless connection, or any combination thereof.

Speaker 614 and microphone 616 of audio equipment 634 may be coupled to audio controller 622 in processing equipment 604. This controller may send and receive signals from audio equipment 634 and perform pre-processing and filtering steps before transmitting signals related to the input signals to processor 624. Speaker 614 and microphone 616 may be coupled directly to processor 624. Connections from audio equipment 634 to processing equipment 604 may be wired, wireless, other suitable arrangements for communicating information, or any combination thereof.

Processing equipment 604 of computer 600 may include display controller 618, sensor controller 620, audio controller 622, processor 624, memory 626, communication controller 628, and power supply 632.

Processor 624 may include circuitry to interpret signals input to computer 600 from, for example, touchscreen 608 and microphone 616. Processor 624 may include circuitry to control the output to display 606 and speaker 614. Processor 624 may include circuitry to carry out instructions of a computer program. In some implementations, processor 624 may be an integrated electronic circuit based, capable of carrying out the instructions of a computer program and include a plurality of inputs and outputs.

Processor 624 may be coupled to memory 626. Memory 626 may include random access memory or RAM, flash memory, programmable read only memory or PROM, erasable programmable read only memory or EPROM, magnetic hard disk drives, magnetic tape cassettes, magnetic floppy disks optical CD-ROM discs, CD-R discs, CD-R1 discs, DVD discs, DVD+R discs, DVD-R discs, any other suitable storage medium, or any combination thereof.

The functions of display controller 618, sensor controller 620, and audio controller 622, as have been described above, may be fully or partially implemented as discrete components in computer 600, fully or partially integrated into processor 624, combined in part or in full into combined control units, or any combination thereof.

Communication controller 628 may be coupled to processor 624 of computer 600. In some implementations, communication controller 628 may communicate radio frequency signals using antenna 630. In some implementations, communication controller 628 may communicate signals using a wired connection, not shown. Wired and wireless communications communicated by communication controller 628 may use Ethernet, amplitude modulation, frequency modulation, bitstream, code division multiple access or CDMA, global system for mobile communications or GSM, general packet radio service or GPRS, satellite, infrared, Bluetooth, Wi-Fi, WiMax, any other suitable communication configuration, or any combination thereof. The functions of communication controller 628 may be fully or partially implemented as a discrete component in computer 600, may be fully or partially included in processor 624, or any combination thereof. In some implementations, communication controller 628 may communicate with a network such as network 504 of FIG. 5 and may receive information from a data graph stored, for example, in database 524 of FIG. 5.

Power supply 632 may be coupled to processor 624 and to other components of computer 600. Power supply 632 may include a lithium-polymer battery, lithium-ion battery, NiMH battery, alkaline battery, lead-acid battery, fuel cell, solar panel, thermoelectric generator, any other suitable power source, or any combination thereof. Power supply 632 may include a hard wired connection to an electrical power source, and may include electrical equipment to convert the voltage, frequency, and phase of the electrical power source input to suitable power for computer 600. In some implementations of power supply 632, a wall outlet may provide 120 volts, 60 Hz alternating current or AC. A circuit of transformers, resistors, inductors, capacitors, transistors, and other suitable electronic components included in power supply 632 may convert the 120V alternating current at 60 Hz from a wall outlet power to 5 volts of direct current at 0 Hz. In some implementations of power supply 632, a lithium-ion battery including a lithium metal oxide-based cathode and graphite-based anode may supply 3.7V to the components of computer 600. Power supply 632 may be fully or partially integrated into computer 600, or may function as a stand-alone device. Power supply 632 may power computer 600 directly, may power computer 600 by charging a battery, may provide power by any other suitable way, or any combination thereof.

The foregoing is merely illustrative of the principles of this disclosure and various modifications may be made by those skilled in the art without departing from the scope of this disclosure. The above described implementations are presented for purposes of illustration and not of limitation. The present disclosure also may take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed:

1. A computer-implemented method comprising:
identifying an occurrence of a first reference to a first person and a second reference to a second person in an unstructured collection of electronic documents;
calculating a relationship metric between the first reference and the second reference, wherein the relationship metric is based at least in part on the co-occurrence of the first reference and the second reference;
determining the existence of a potential connection between the first reference and the second reference based at least in part on the relationship metric;
providing a recommendation to at least one of the first person and the second person to acknowledge the potential connection as an actual connection; and
receiving input from at least one of the first person and the second person confirming the potential connection as an actual connection.

2. The method of claim 1, wherein identifying an occurrence of at least one of the first reference and the second reference comprises mapping a reference in at least one document of the collection of electronic documents to a reference in a list.

3. The method of claim 1, wherein determining the existence of a potential connection comprises comparing the relationship metric to a threshold.

4. The method of claim 1, wherein the relationship metric is determined based at least in part on the location of at least one of the first reference and the second reference in one of the documents of the collection of electronic documents.

5. The method of claim 1, wherein the relationship metric is determined based at least in part on the distance between the occurrence of the first reference and the occurrence of the second reference in one of the documents of the collection of electronic documents.

6. The method of claim 1, wherein the relationship metric is determined based at least in part on a number of occurrences of at least one of the first reference and the second reference in at least one of the documents of the collection of electronic documents.

7. The method of claim 1, wherein the relationship metric is determined based at least in part on a quality metric associated with one or more of the documents of the collection of electronic documents.

8. The method of claim 1, further comprising augmenting social connection data associated with at least one of the first person and the second person based on the actual connection.

9. A system comprising:
one or more computers configured to perform operations comprising:
identifying an occurrence of a first reference to a first person and a second reference to a second person in an unstructured collection of electronic documents;
calculating a relationship metric between the first reference and the second reference, wherein the relationship metric is based at least in part on the co-occurrence of the first reference and the second reference;
determining the existence of a potential connection between the first reference and the second reference based at least in part on the relationship metric;
providing a recommendation to at least one of the first person and the second person to acknowledge the potential connection as an actual connection; and
receiving input from at least one of the first person and the second person confirming the potential connection as an actual connection.

10. The system of claim 9, wherein identifying an occurrence of at least one of the first reference and the second reference comprises mapping a reference in at least one document of the collection of electronic documents to a reference in a list.

11. The system of claim 9, wherein determining the existence of a potential connection comprises comparing the relationship metric to a threshold.

12. The system of claim 9, wherein the relationship metric is determined based at least in part on the location of at least one of the first reference and the second reference in one of the documents of the collection of electronic documents.

13. The system of claim 9, wherein the relationship metric is determined based at least in part on the distance between the occurrence of the first reference and the occurrence of the second reference in one of the documents of the collection of electronic documents.

14. The system of claim 9, wherein the relationship metric is determined based at least in part on a number of occurrences of at least one of the first reference and the second reference in at least one of the documents of the collection of electronic documents.

15. The system of claim 9, wherein the relationship metric is determined based at least in part on a quality metric associated with one or more of the documents of the collection of electronic documents.

16. The system of claim 9, wherein the one or more computers are configured to perform operations further comprising augmenting social connection data associated with at least one of the first person and the second person based on the actual connection.

17. A computer-readable medium storing instructions that, when executed by one or more processors, cause the one or more processors to perform operations comprising:
identifying an occurrence of a first reference to a first person and a second reference to a second person in an unstructured collection of electronic documents;
calculating a relationship metric between the first reference and the second reference, wherein the relationship metric is based at least in part on the co-occurrence of the first reference and the second reference;
determining the existence of a potential connection between the first reference and the second reference based at least in part on the relationship metric;
providing a recommendation to at least one of the first person and the second person to acknowledge the potential connection as an actual connection; and
receiving input from at least one of the first person and the second person confirming the potential connection as an actual connection.

18. The computer-readable medium of claim 17, wherein identifying an occurrence of at least one of the first reference and the second reference comprises mapping a reference in at least one document of the collection of electronic documents to a reference in a list.

19. The computer-readable medium of claim 17, wherein determining the existence of a potential connection comprises comparing the relationship metric to a threshold.

20. The computer-readable medium of claim 17, wherein the relationship metric is determined based at least in part on the location of at least one of the first reference and the second reference in one of the documents of the collection of electronic documents.

21. The computer-readable medium of claim 17, wherein the relationship metric is determined based at least in part on the distance between the occurrence of the first reference and the occurrence of the second reference in one of the documents of the collection of electronic documents.

22. The computer-readable medium of claim 17, wherein the relationship metric is determined based at least in part on a number of occurrences of at least one of the first reference and the second reference in at least one of the documents of the collection of electronic documents.

23. The computer-readable medium of claim 17, wherein the relationship metric is determined based at least in part on a quality metric associated with one of the documents of the collection of electronic documents.

24. The computer-readable medium of claim 17, that, when executed by one or more processors, cause the one or more processors to perform operations further comprising augmenting social connection data associated with at least one of the first person and the second person based on the actual connection.
